(19) United States
(12) Patent Application Publication
(10) Pub. No.: US 2007/0147826 A1
(43) Pub. Date: Jun. 28, 2007

(54) Photographing system and photographing method

(75) Inventors: Hiroshi Matsuzaki, Tachikawa-shi (JP); Fumiyuki Shiratani, Sagamihara-shi (JP); Nobuyuki Watanabe, Yokohama-shi (JP); Satoko Furuki, Utsunomiya-shi (JP); Akikazu Yachi, Hachioji-shi (JP); Hideki Nagata, Hachioji-shi (JP); Toru Matsuzawa, Kunitachi-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS CORPORATION, Tokyo (JP)

(21) Appl. No.: 11/604,480

(22) Filed: Nov. 27, 2006

(30) Foreign Application Priority Data
Dec. 22, 2005 (JP) 2005-370108

(51) Int. Cl. G03B 17/18

(52) U.S. Cl. 396/287

(57) ABSTRACT

In a scene recognition photographing device of the present invention, a feature quantity of an acquired image acquired from an image pickup element is calculated from the acquired image. Plural types of reference feature information having a feature quantity serving as a reference at the time of determining a composition are stored as a database in an internal memory or a storage device. Moreover, a camera control unit retrieves reference feature information having a feature quantity similar to the feature quantity of the acquired image from among the reference feature information by comparing the calculated feature quantity and the reference feature information. Then, information relating to composition is displayed on a display device on the basis of a result of comparison between the acquired image and the retrieved reference feature information.

### CROSS-REFERENCE TO RELATED APPLICATIONS

This application is based upon and claims the benefit of priority from prior Japanese Patent Application No. 2005-370108, filed Dec. 22, 2005, the entire contents of which are incorporated herein by reference.

### BACKGROUND OF THE INVENTION

1. Field of the Invention

The present invention relates to a photographing system and a photographing method for indicating information to a user so as to acquire an image satisfactorily composed.

2. Description of the Related Art

In recent years, highly functional digital cameras have been advanced, which has made it possible to set a variety of photographing modes. Such digital cameras have been able to carry out photographing in automatic exposure (AE) and at shutter speeds suitable for various photographing modes.

However, it has been still difficult for beginners to appropriately determine a composition of a photograph. Moreover, subjectively favorite compositions are different from one another for every user.

Therefore, a camera has been known in which a photographing advice according to a photographing object is displayed on a display screen when a user selects a photographing mode desired to be carried out from among a plurality of photographing modes (for example, refer to Jpn. Pat. Appln. KOKAI Publication No. 2000-333045). The camera calls attention to a user so as to not make a mistake in photographing in such a manner that an icon corresponding to a selected photographing mode is displayed on the display screen, and a photographing advice corresponding to the photographing mode is displayed.

Further, Jpn. Pat. Appln. KOKAI Publication No. 2001-330882 discloses a camera comprising: object recognition means for recognizing object information to be photographed on the basis of an output from an area sensor; and control means for controlling photographing functions of the camera in accordance with a recognition result by the object recognition means, the object recognition means changing algorithm for recognizing object information in accordance with a set photographing mode.

Moreover, in Jpn. Pat. Appln. KOKAI Publication No. 2004-214760, there is disclosed a method in which a plurality of related structural images are extracted from positional information provided to image data at the time of photographing with reference to the positional information, and a correlation value of a photographed image and the plurality of related structural images extracted is calculated to estimate structures included in an image with a highest correlation to be an object as the photographed image.

### BRIEF SUMMARY OF THE INVENTION

Accordingly, an object of the present invention is to provide a photographing system and a photographing method by which it is possible even for a beginner to easily acquire an image satisfactorily composed.

That is, a photographing system of the present invention comprises: a calculation unit which calculates a feature quantity of an acquired image acquired from an image pickup element; a database which stores plural types of reference feature information having a feature quantity serving as a reference at a time of determining a composition; a retrieval unit which retrieves reference feature information from the database having a feature quantity similar to the calculated feature quantity of the acquired image by comparing the feature quantity calculated in the calculation unit and the reference feature information stored in the database; and a report unit which reports information relating to the composition on the basis of a result of comparison between the calculated feature quantity and the reference feature information retrieved by the retrieval unit.

Further, a photographing method for assisting in composing a scene according to the present invention, comprises: a first step of calculating a feature quantity of an acquired image acquired from an image pickup element; a second step of retrieving reference feature information from a database having a feature quantity similar to the calculated feature quantity of the acquired image by comparing the calculated feature quantity and reference feature information having a feature quantity serving as a reference at a time of determining a composition, which are stored in the database; and a third step of reporting information relating to the composition on the basis of a result of comparison between the calculated feature quantity and the retrieved reference feature information.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a basic configuration of a camera to which a photographing system according to a first embodiment of the present invention is applied.

FIG. 2 shows a structure of the camera in the first embodiment of the invention, and is a rear view as seen from the rear of the camera.

FIG. 3 explains photographing operations of the camera in the first embodiment of the invention, and is a flowchart for setting a satisfactory composition by indicating a moving direction of the camera.

FIG. 4A shows an example of an image displayed on a liquid crystal finder at the time of setting a satisfactory composition by indicating a moving direction of the camera in the first embodiment, and is a view showing an example of an input image.

FIG. 4B shows an example of an image displayed on the liquid crystal finder at the time of setting a satisfactory composition by indicating a moving direction of the camera in the first embodiment, and is a view showing an example of a similar image.

FIG. 5 explains photographing operations of the camera in the first embodiment of the invention, and is a flowchart for setting a satisfactory composition by assisting a zoom operation of the camera.

FIG. 6A shows an example of an image displayed on the liquid crystal finder at the time of assisting a zoom operation of the camera in the first embodiment, and is a view showing an example of an input image.

FIG. 6B shows an example of an image displayed on the liquid crystal finder at the time of assisting a zoom operation of the camera in the first embodiment, and is a view showing an example of a similar image.

FIG. 7 is a block diagram showing a configuration of a camera to which a photographing system according to a second embodiment of the present invention is applied.

FIG. 8 is a flowchart for explanation of photographing operations of the camera in the second embodiment of the invention.

FIG. 9 is a flowchart for explanation of photographing operations of a camera according to a fifth embodiment of the present invention.

FIG. 10A shows an example of an image displayed on a liquid crystal finder at the time of assisting a manipulation of the camera in the fifth embodiment, and is a view showing an example of an input image.

FIG. 10B shows an example of an image displayed on the liquid crystal finder at the time of assisting a manipulation of the camera in the fifth embodiment, and is a view showing an example of a similar image.

FIG. 11 is a flowchart for explanation of photographing operations of a camera according to a sixth embodiment of the present invention.

FIG. 12A shows an example of an image displayed on a liquid crystal finder at the time of assisting a manipulation of the camera in the sixth embodiment, and is a view showing an example of an input image.

FIG. 12B shows an example of an image displayed on the liquid crystal finder at the time of assisting a manipulation of the camera in the sixth embodiment, and is a view showing an example in which the input image and a similar image are simultaneously displayed.

FIG. 13 is a diagram schematically showing a configuration of a camera system to which a photographing system according to a seventh embodiment of the present invention is applied.

### DETAILED DESCRIPTION OF THE INVENTION

Hereinafter, embodiments of the present invention will be describe with reference to the drawings.

### First Embodiment

FIG. 1 is a block diagram showing a basic configuration of a camera serving as an image pickup device to which a photographing system according to a first embodiment of the present invention is applied.

In FIG. 1, the camera is configured to have a camera control unit 10, an optical system 12, a zoom control unit 14, an image pickup element 16, a photographing mode setting unit 18, an internal memory 20, a storage device 22, a display device 24, and an operating unit 26.

The camera control unit 10 is to manage control operations overall of the camera as control means, and has also functions serving as calculation means and retrieval means for image features. The optical system 12 is configured to have a photographing lens and the like, and is controlled in its position in an optical axis direction by the zoom control unit 14 in accordance with an instruction from the camera control unit 10. Further, the image pickup element 16 is provided to form an optical image of an object incident via the optical system 12, and is configured by a CCD or the like. The optical image captured by the image pickup element 16 is converted into an electrical signal via an image processing unit (not shown), and the electrical signal is output to the camera control unit 10.

The photographing mode setting unit 18 is designed to set a photographing mode of the camera in photographing. A plurality of reference images are stored in the internal memory 20 and the storage device 22 as reference feature quantity information having a feature quantity which will be a reference (a reference feature quantity) at the time of determining a composition. A feature quantity is an index denoting a feature of an image. For example, a feature quantity is determined on the basis of at least one or all of a color ratio, a histogram of brightness, texture information, and the like. By retrieving these reference feature quantities stored in the internal memory 20 and storage device 22, a composition is set as will be described later.

Information relating to an image and a composition of a photographed object, or the like is displayed on the display device 24 which functions as report means. In addition, the operating unit 26 configures operation means, and is composed of a switch group including manual operation buttons required for operating the camera, such as a release switch or a zoom switch for instructing to execute photographing operations, a power switch, and a switch group 26a which will be described later.

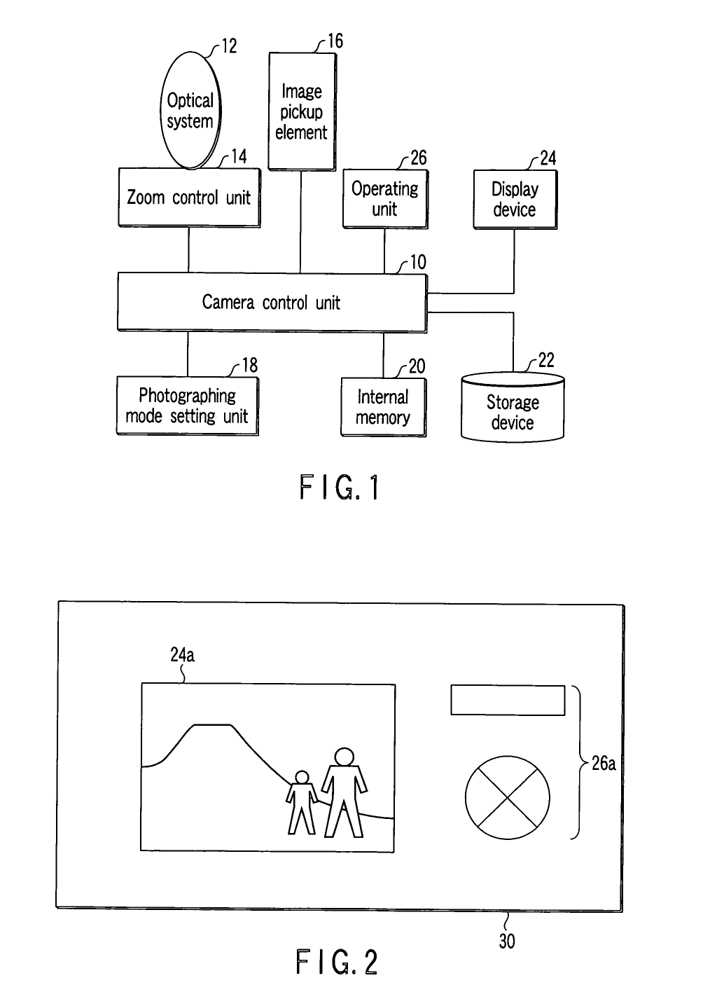

FIG. 2 shows a structure of the camera in the first embodiment of the invention, and is a rear view as seen from the rear of the camera.

A liquid crystal finder 24a serving as the display device 24 and the operating switch group 26a configuring part of the operating unit 26 are provided at the rear face side of the camera 30. The operating switch group 26a is composed of a decision button and a direction indicator button.

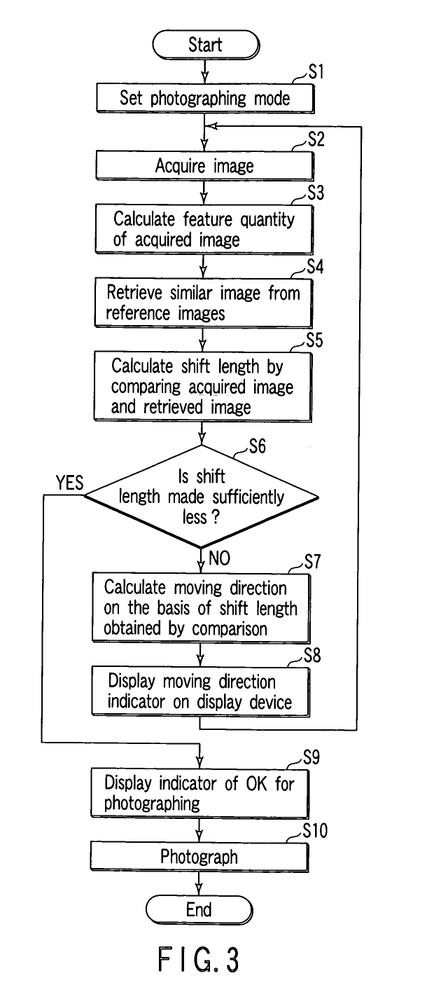

Next, photographing operations of the camera in the first embodiment of the invention will be described with reference to a flowchart of FIG. 3. First, a case in which a satisfactory composition is set by indicating a moving direction of the camera will be described.

When this sequence is started, a photographing mode is first set in step S1. A photographing mode is a photographing condition set with conditions in automatic exposure, a shutter speed, auto focusing, and contents of image processing onto a photographed image being changed in accordance with a type of a scene which a user makes an attempt to photograph. Examples of the photographing mode include a portrait mode corresponding to a scene for photographing persons, a landscape mode corresponding to a scene for photographing a distant object, a macro mode corresponding to a scene for photographing a close object, a ceremonial photograph mode corresponding to a scene for photographing persons and a distant landscape simultaneously, and a self-portrait mode which is a scene that a user photographs himself/herself with a camera in his/her hand. In step S1, a selected photographing mode is set in advance of photographing by operating the operation buttons in accordance with a scene which the user makes an attempt to photograph.

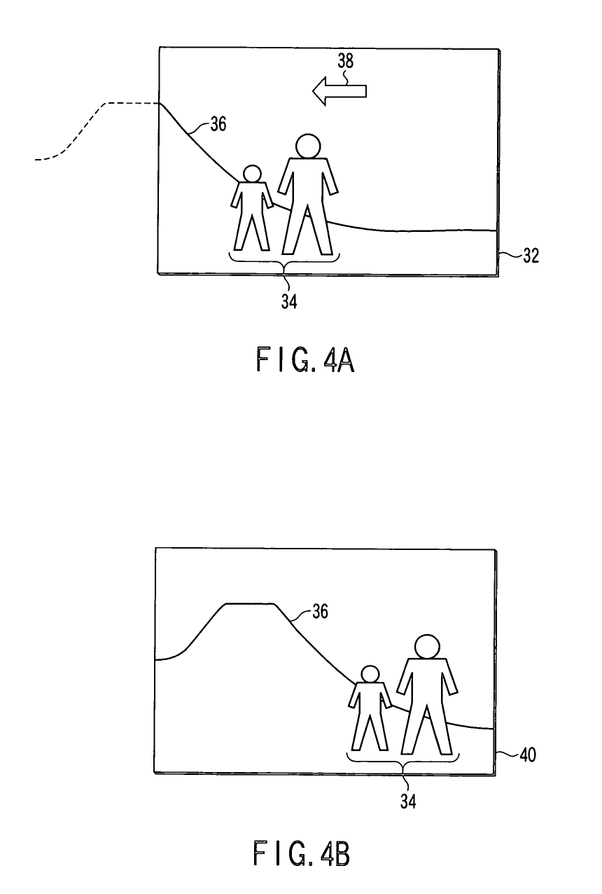

Next, in step S2, an image of the object is acquired from the image pickup element 16 via the optical system 12. The image of the object acquired in step S2 may be an image acquired by so-called pre-photographing, or may be an image acquired by so-called actual photographing. For example, suppose that an acquired image herein (input image) is composed as shown in FIG. 4A. The composition in this case is an image 32 in which an object 34 and a part of a mountain 36 in the background are shown up.

Subsequently, in step S3, a feature quantity of the image is calculated in the camera control unit 10 from an image signal of the image acquired in the step S2. Then, in step S4, a similar image similar to the image acquired in the step S2 is retrieved from among the reference images stored in the internal memory 20 or the storage device 22 on the basis of the feature quantity. Namely, by comparing a feature quantity calculated from the image acquired in step S2 with the reference images, a reference image having a feature quantity similar to the feature quantity of the image acquired in step S2 is extracted as a similar image. Note that the reference images have ideal compositions prepared for each photographing mode. For example, in step S4, an image composed as shown in FIG. 4B is retrieved as a similar image 35.

In step S5, the acquired image acquired in the step S2 is compared with the similar image retrieved in the step S4 to calculate a gap between the both in the camera control unit 10. Next, in step S6, a measure of a shift length is determined. When, as a result of the determination, it is determined that a shift length is sufficiently small, i.e., that it is similar to the composition of the similar image 40, the routine proceeds to step S9. On the other hand, when it is determined that a shift length is large, the routine proceeds to step S7.

Then, in step S7, a changing direction (moving direction) of the composition is calculated in order to change the composition of the acquired image 32 shown in FIG. 4A into the composition of the similar image 40 shown in FIG. 4B on the basis of the shift length obtained as the result of the comparison in the step S6. Next, in step S8, an indicator display 38 is displayed (the image 32) in the liquid crystal finder 24a of the display device 24 in order to report to the user that the composition is changed in the calculated moving direction.

Thereafter, when the user carries out photographing again after adjusting the composition of the camera 30 in accordance with the indicator display 38 in the liquid crystal finder 24a, the processings on and after step S2 are repeated.

When it is determined that the acquired image 32 and the similar image 40 are similar to each other, an indicator of OK for photographing is displayed in the liquid crystal finder 24a in step S9 (not shown in the drawing). In step S10, the user can carry out actual photographing with the composition which is determined as OK in the step S9.

Here, a measure of a shift length can be analogized on the basis of a state of a change in degree of similarity by shifting the positions of the acquired image and the retrieved image in comparison of the feature quantities. More specifically, the retrieved image is shifted subtly in the up and down, and left and right directions, a change in degree of similarity is observed, and a direction in which a degree of similarity is increased is retrieved. Further, the image is shifted in a direction in which a degree of similarity is increased, and a shift length at which a degree of similarity is made to be a relative minimum is determined on the basis of a functional relationship between a plurality of shifted lengths and values of degrees of similarity accompanied therewith, which leads to the value being an initial shift length. Accordingly, the shift length described above at which a degree of similarity is made to be a relative minimum is to solve an optimization problem such as a steepest descent method or a method of least squares.

The above description is an example of the case in which a satisfactory composition is set by indicating a moving direction of the camera.

In this way, there is a high possibility that there is a positional gap between an input image captured by the image pickup element 16 and a similar image retrieved for the input image. However, in the case where the similar image is satisfactorily composed, a moving direction which is a direction in which the camera must be moved so as to be arranged to be close to the retrieved similar image by moving in parallel, or panning, or tilting the photographing device is displayed as information relating to the composition in the liquid crystal finder 20a. Consequently, the user can set appropriately the current composition until the current composition becomes the composition similar to the composition of the similar image by operating the camera in accordance with the display.

As described above, in the present embodiment, a moving direction of the composition is calculated on the basis of a gap between an acquired image and a similar image, but the invention is not limited thereto. The invention may be configured in such a manner that a difference in size between objects in an acquired image and a similar image is calculated, a display for indicating a change in a zoom quantity is output depending on the difference in size, and composition setting is assisted such that compositions of the retrieved similar image and the acquired image are made similar to each other.

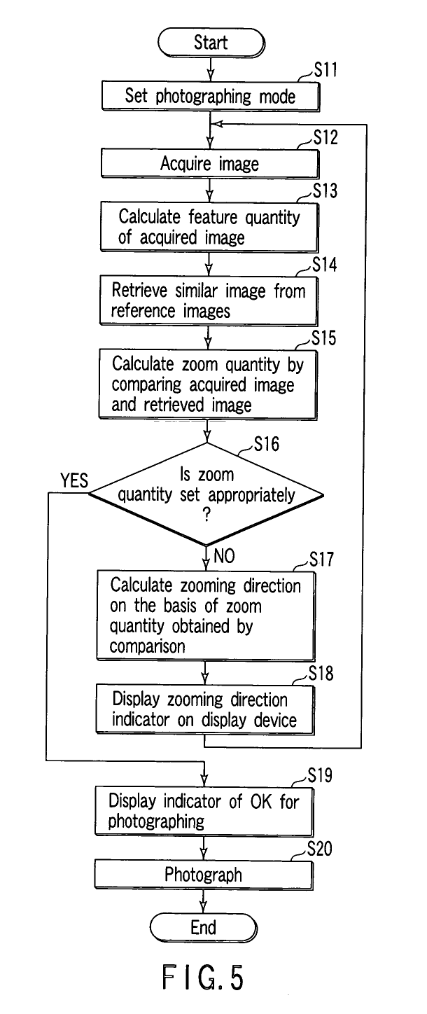

Next, such photographing operations of the camera when setting a satisfactory composition by assisting a zoom operation will be described with reference to a flowchart of FIG. 5.

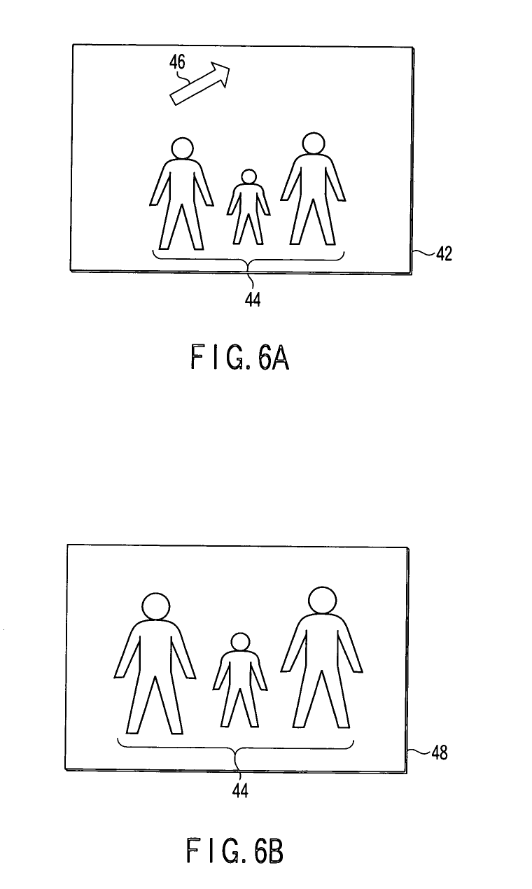

When this sequence is started, a photographing mode is first set in step S11. Next, in step S12, an image of an object is acquired from the image pickup element 16 via the optical system 12. The image of the object acquired in the step S12 may be an image acquired by so-called pre-photographing, or may be an image acquired by so-called actual photographing. For example, suppose that an acquired image herein (input image) is composed as shown in FIG. 6A. The composition in this case is an image 42 in which an object 44 is shown up in substantially the half of the screen.

Subsequently, in step S13, a feature quantity of the image is calculated in the camera control unit 10 from an image signal of the image acquired in the step S12. Here, a feature quantity is, for example, a color ratio, a histogram of brightness, and texture information. Then, in step S14, a similar image similar to the image acquired in the step S12 is retrieved from among the reference images stored in the internal memory 20 or the storage device 22 on the basis of the feature quantity. Note that the reference images have ideal compositions prepared for each photographing mode, and for example, composition as shown in FIG. 6B is retrieved as a similar image 48.

In step S15, a zoom quantity is calculated in the camera control unit 10 through comparison between the acquired image acquired in the step S12 and the similar image retrieved in the step S14. Next, in step S16, a measure of a zoom quantity is determined. When, as a result of the determination, it is determined that a zoom quantity is appropriate, i.e., that it is similar to the composition of the similar image 48, the routine proceeds to step S19. On the other hand, when it is determined that a zoom quantity is not appropriate yet, the routine proceeds to step S17.

Then, in step S17, a zoom quantity and zooming direction are calculated in order to zoom up (or zoom down) the composition of the image 42 shown in FIG. 6A so as to be the composition of the similar image 48 shown in FIG. 6B on the basis of the zoom quantity obtained as the result of the comparison in the step S16. Next, in step S18, a display 46 for a zoom quantity or a direction of changing a zoom quantity (a zooming direction) is displayed in the liquid crystal finder 24a of the display device 24 (the image 42) in order to cause the user to perform a zoom-up (or zoom-down) operation of the camera 30. In this case, because the display 46 serving as an arrow is directed to the upper right, it can be understood that a zoom-up operation is prompted. Although not shown in the drawing, a zoom-down operation is prompted when the display serving as an arrow is directed to the lower right. Further, for example, it is possible to report a zoom quantity by a color or a size of an arrow.

Thereafter, when the user performs a zoom-up (or zoom-down) operation of the camera 30 in accordance with the arrow display 46 in the liquid crystal finder 24a to carry out photographing again after adjusting the composition, the processings on and after step S12 are repeated.

When it is determined that the acquired image 42 and the similar image 48 are similar to each other, an indicator of OK for photographing is displayed (not shown in the drawing) in the liquid crystal finder 24a in step S19. Then, in step S20, actual photographing is carried out with the composition which is determined as OK in the step S19.

The above-description is an example of the case in which a satisfactory composition is set by instructing a zoom operation of the camera.

Note that, in the example described above, a zooming direction is displayed in the liquid crystal finder 24a, and the user changes the zooming in accordance with the display. However, it is not limited thereto, and a zoom quantity may be automatically changed at the camera side.

In this way, when a zoom value is not appropriate in an input image captured by the image pickup element, a zoom quantity or a direction of changing a zoom quantity are reported as information relating to the composition, whereby it is possible to provide to the user information by which more appropriate setting for composition can be made.

Further, a function serving as direction finding means is provided to the camera control unit 10, and it is determined whether the composition is vertical composition or transverse composition by detecting whether the longitudinal direction of the composition is a horizontal direction or a vertical direction, so that appropriate assistance for composition may be performed for each composition. Namely, when it is determined that the composition is vertical composition, retrieval is made with respect to reference images in vertical composition, so that a reference image in vertical composition is retrieved. When it is determined that the composition is transverse composition, retrieval is made with respect to reference images in transverse composition, so that a reference image in transverse composition is retrieved.

Note that the display device 24 has been described as report means. However, a lamp provided as report means separately from the liquid crystal finder 24a may be used to report a moving direction, or a zoom quantity and zooming direction by a lighting pattern of the lamp. For example, if a lamp is separately provided on a surface opposite to the surface on which the liquid crystal finder 24a is mounted, it is easy to adjust the composition at the time of photographing a user himself/herself (for example, in the case where a self-portrait mode or a ceremonial photograph mode is set). The camera control unit 10 may make a control such that the lamp provided separately from the liquid crystal finder 24a is used as report means when a self-portrait mode is set, and that the liquid crystal finder 24a is used as report means when another photographing mode is set.

Further, a moving direction or a zoom quantity may be reported with sound or voice by using speakers as report means. Moreover, report of a moving direction, or a zoom quantity and zooming direction in the present embodiment includes, in addition to a case of directly reporting a moving direction, or a zoom quantity and zooming direction, a case of reporting only information on whether the composition is appropriate or not, i.e., the camera is directed in a favorable direction or not, or whether or not a zoom quantity is appropriate.

As described above, in accordance with the first embodiment, a difference from an input image is displayed through comparison with an image similar to an image satisfactorily composed registered as a reference image. Consequently, the user can carry out fine adjustment onto the composition on the basis of the displayed information, which makes it possible to set a satisfactory composition.

### Second Embodiment

Next, a second embodiment of the present invention will be described.

In the first embodiment described above, an input image and a similar image are compared with each other to makes it possible for a user to more appropriately set a composition in accordance with a shift length or a zoom quantity as a result of the comparison. However, in addition to the configuration of the first embodiment, the invention may be configured such that a direction control unit is provided to make it possible to set a satisfactory composition by controlling a direction of the camera in accordance with the shift length.

Hereinafter, the second embodiment will be described. The basic configuration of the camera is the same as that in the first embodiment shown in FIG. 1, and the basic photographing operations are also the same. Accordingly, with respect to these configuration and operations, the same components as those in the first embodiment are denoted by the same reference numerals, and illustrations and descriptions thereof will be omitted. Only a configuration and operations of different components will be described.

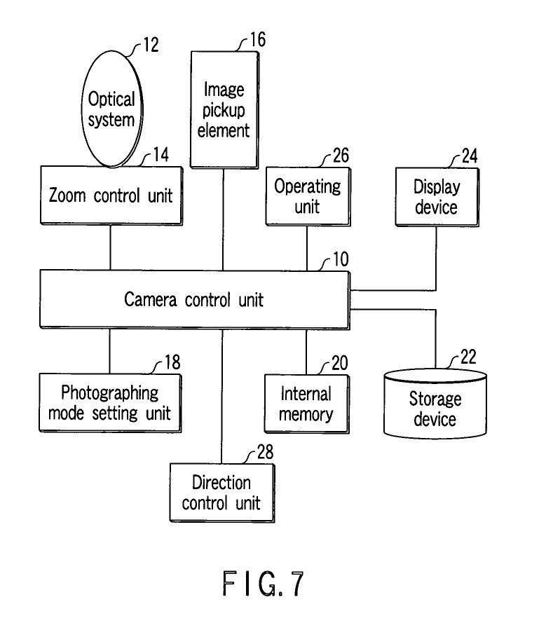

FIG. 7 is a block diagram showing a configuration of a camera to which a photographing system according to the second embodiment of the invention is applied.

In FIG. 7, a direction control unit 28 for controlling a direction of the camera is further connected to the camera control unit 10. The direction control unit 28 is to change a direction of the camera attached to, for example, a tripod with motor (not shown) by providing a control signal to the motor in accordance with a determined shift length.

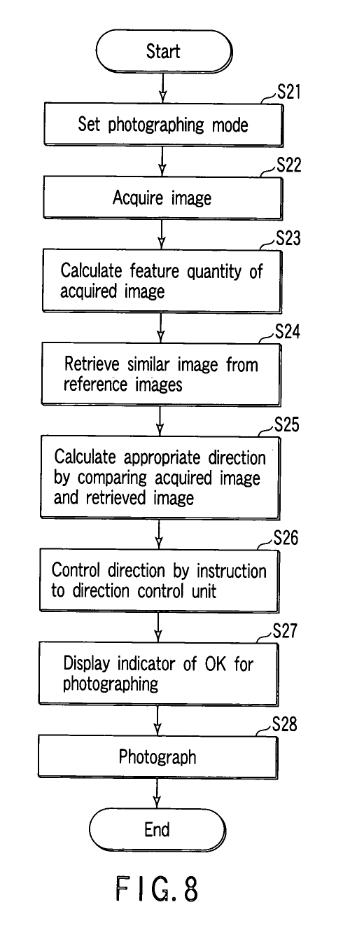

Next, photographing operations of the camera in the second embodiment of the invention will be described with reference to a flowchart of FIG. 8.

When this sequence is started, in the same way as in the first embodiment described above, a photographing mode is first set in step S21. Next, in step S22, an image of an object (not shown) is acquired by the image pickup element 16 via the optical system 12 (refer to FIG. 4A).

Next, in step S23, a feature quantity of the image is calculated in the camera control unit 10 from an image signal of the image acquired in the step S22. Then, in step S24, a similar image similar to the image acquired in the step S22 is retrieved from among the reference images stored in the internal memory 20 or the storage device 22 on the basis of the feature quantity.

In step S25, an appropriate direction is calculated in the camera control unit 10 by comparing the acquired image acquired in the step S22 and the similar image retrieved in the step S24. Then, in step S26, an instruction is output from the camera control unit 10 to the direction control unit 28, and a control signal to the motor is output in order to change a direction of the camera (refer to FIG. 4B) in a direction as the result of the comparison in the step S25. The motor is operated in accordance with the control signal.

Subsequently, when an indicator of OK for photographing is displayed in the liquid crystal finder 24a in step S27, actual photographing is carried out in the following step S28 with the composition which is determined as OK in step S27.

In this way, according to the second embodiment, an input image and a similar image are compared to determine a direction in which the camera must be moved on the basis of a difference between the images, and a direction of the camera is controlled by the moving direction control unit 28. This makes it possible to carry out photographing of the camera with a satisfactory composition.

### Third Embodiment

Next, a third embodiment of the present invention will be described.

In the first and second embodiments described above, all the reference images are objects to be retrieved with respect to the reference images serving as reference feature information. In the third embodiment, reference feature information serving as objects to be retrieved are classified into the photographing modes.

Note that, in the third embodiment which will be described hereinafter, the basic configuration of the camera is the same as that in the first embodiment shown in FIG. 1, and the basic photographing operations are also the same. Accordingly, with respect to these configuration and operations, the same components as those in the first embodiment are denoted by the same reference numerals, and illustrations and descriptions thereof will be omitted and only different partial operations will be described.

The reference images are stored in the internal memory 20 or the storage device 22 in the first embodiment. In the third embodiment, they are classified for each of the photographing modes to be stored. For this reason, when a similar image is retrieved from among the reference images in step S4, step S14, or step S24, an image with a composition classified so as to correspond to a photographing mode set in step S21 is retrieved.

Accordingly, unlike the first and second embodiments, a reference image is not retrieved from among the images with all the compositions, but it suffices to retrieve reference images classified for each of the photographing modes. As a consequence, it is easy to retrieve an image suitable for a photographing mode.

Note that the above-described example has described the example of the case where a satisfactory composition is set by indicating a moving direction of the camera. However, because it is the same as in the case where a satisfactory composition is set by instructing a zoom operation, description thereof here will be omitted.

In this way, in accordance with the third embodiment, a retrieval time is shortened because the reference images are classified for each of the photographing modes. In addition, scenes are limited due to the classification into photographing modes being carried out, which makes it possible to carry out precise retrieval.

### Fourth Embodiment

### Next, a fourth embodiment of the present invention will be described.

In the fourth embodiment, reference images which are reference feature information serving as objects to be retrieved can be set at a user side.

Note that, in the fourth embodiment which will be described hereinafter, the basic configuration of the camera is the same as that in the first embodiment shown in FIG. 1, and the basic photographing operations are also the same. Accordingly, with respect to these configuration and operations, the same components as those in the first embodiment are denoted by the same reference numerals, and illustrations and descriptions thereof will be omitted and only different partial operations will be described.

That is, in the fourth embodiment, the reference images stored in the internal memory 20 or the storage device 22 are registered in advance in accordance with a taste of a user, for example, by operating the operating unit 26. As one example, configuration can be made such that, from among the plurality of reference images stored in the internal memory 20 or the storage device 22, only reference images registered in advance depending on selections by a user are made to be objects to be retrieved in step S4, step S14, or step S24. In addition thereto, or as another example, configuration can be made such that images of user's preference are stored in advance in the internal memory 20 or the storage device 22 as reference images. All the reference images may be images of user's preference. Some of the reference images may be stored in advance, and only some of the other reference images may be images of user's preference. Images of user's preference may be images stored in the internal memory 20 or the storage device 22 in such a manner that the user himself/herself photographs with camera, or may be images captured into the internal memory 20 or the storage device 22 from the exterior. Consequently, it is possible to set an image satisfactorily composed according to a subjective point of view of each user.

### Fifth Embodiment

Next, a fifth embodiment of the present invention will be described.

The fifth embodiment is configured such that, when persons are included in an input image, a similar image is retrieved from among the reference images by detecting face images of the persons. Among various scenes, the compositions including persons are compositions to be objects to be photographed in relatively many cases. Technologies of recognizing faces of persons have been well known. For this reason, in the present embodiment, assistance is achieved so as to obtain an image with the optimum composition by extracting face areas as a feature quantity by utilizing these technologies.

Hereinafter, the fifth embodiment of the invention will be described. However, the basic configuration of the camera is the same as that in the first embodiment shown in FIG. 1, and the basic photographing operations are also the same. Accordingly, with respect to these configuration and operations, the same components as those in the first embodiment are denoted by the same reference numerals, and illustrations and descriptions thereof will be omitted and only different partial operations will be described.

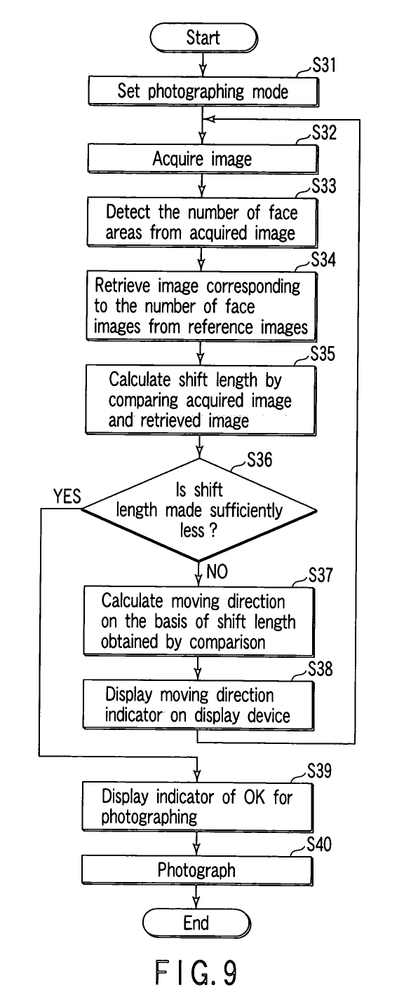

FIG. 9 is a flowchart for explanation of photographing operations of a camera according to the fifth embodiment of the invention.

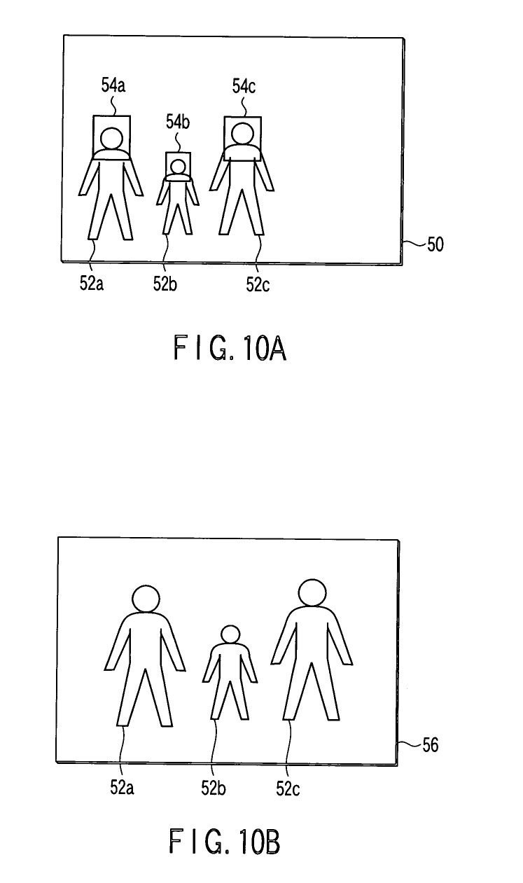

When this sequence is started, in the same way as in the first and second embodiments described above, a photographing mode is first set in step S31. Next, in step S32, an image of an object is acquired from the image pickup element 16 via the optical system 12. The image of the object acquired in the step S32 may be an image acquired by so-called pre-photographing, or may be an image acquired by so-called actual photographing. For example, suppose that an acquired image herein (input image) is composed as shown in FIG. 10A. The composition in this case is an image 50 in which objects 52a to 52c are shown up in substantially the half of the screen and in the left side.

Next, in step S33, the camera control unit 10 serving as face image detecting means detects the number of face areas (face images) from an image signal of the image acquired in the step S32. In this case, the number of face images are three of 54a, 54b and 54c corresponding to the objects 52a, 52b and 52c. Note that, because the detection of face areas is a well-known technology, description thereof here will be omitted. Then, in the following step S34, images having the number of face images corresponding to the number of face images acquired in the step S33 are retrieved from among the reference images stored in the internal memory 20 or the storage device 22.

In step S35, the acquired image acquired in the step S32 is compared with the similar image retrieved in the step S34 to calculate a shift length and a zoom quantity in the camera control unit 10. Next, in step S36, measures of a shift length and a zoom quantity are determined. When, as a result of the determination, it is determined that a shift length and a zoom quantity are appropriate, i.e., that it is similar to the composition of a similar image 56 as shown in FIG. 10B, the routine proceeds to step S39. On the other hand, when it is determined that they are not appropriate yet, the routine proceeds to step S37.

Then, in step S37, a direction and a zoom quantity is calculated in order to move the camera on the basis of the zoom quantity obtained as a result of the comparison in the step S35. Subsequently, in step S38, an indicator display and a zooming direction indicator are displayed in the liquid crystal finder 24a of the display device 24 (not shown in the drawing) in order to report to a user that the composition is changed in a calculated moving direction.

Thereafter, when the user carries out photographing again after adjusting the composition of the camera 30 in accordance with the indicator display in the liquid crystal finder 24a, the processings on and after the step S32 are repeated.

When it is determined that the acquired image 50 and the similar image 56 are similar to each other, an indicator of OK for photographing is displayed (not shown in the drawing) in the liquid crystal finder 24a in step S39. In step S40, the user can carry out actual photographing with the composition which is determined as OK in the step S39.

In this way, according to the fifth embodiment, face areas of an input image are extracted to compare degrees of similarities with the reference images, which makes it possible to carry out more precise retrieval. In addition, a reference image expressing the input image better can be obtained, and assistance can be made for setting a favorable composition.

### Sixth Embodiment

Next, a sixth embodiment of the present invention will be described.

In the first to fifth embodiments described above, only the input image is displayed on the liquid crystal finder 24a, and indicator displays of a moving direction, or a zoom quantity and zooming direction of the camera are displayed as information relating to the composition. In this sixth embodiment, a similar image is displayed along with an input image in the liquid crystal finder 24a as information relating to the composition.

Hereinafter, the sixth embodiment will be described. However, the basic configuration of the camera is the same as that in the first to fifth embodiments shown in FIGS. 1 to 10A and 10B, and the basic photographing operations are also the same. Accordingly, with respect to these configuration and operations, the same components as those in the first to fifth embodiments are denoted by the same reference numerals, and illustrations and descriptions thereof will be omitted and only different partial operations will be described.

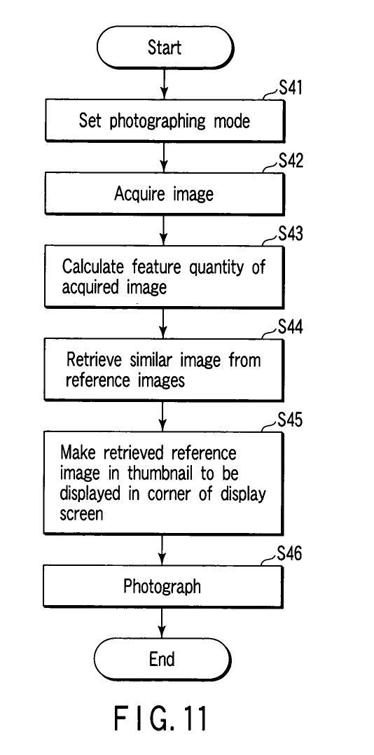

FIG. 11 is a flowchart for explanation of photographing operations of a camera according to the sixth embodiment of the invention.

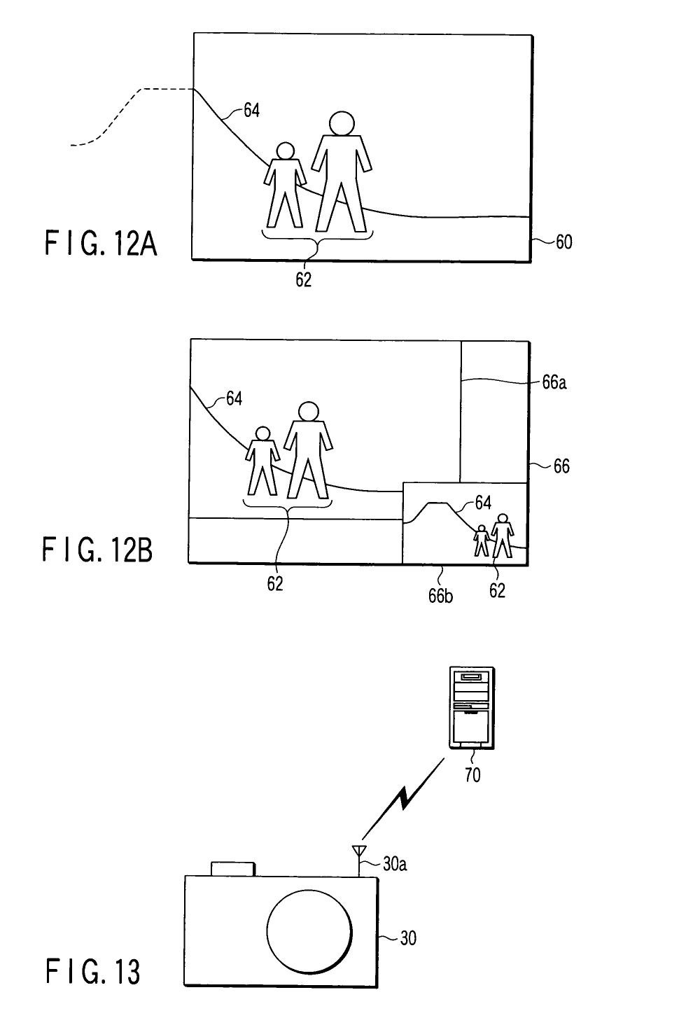

When this sequence is started, a photographing mode is first set in step S41. Next, in step S42, an image of an object is acquired from the image pickup element 16 via the optical system 12. The image of the object acquired in the step S42 may be an image acquired by so-called pre-photographing, or may be an image acquired by so-called actual photographing. For example, suppose that an acquired image herein (input image) is composed as shown in FIG. 12A. The composition in this case is an image 60 in which an object 62 and a part of a mountain 64 in the background are shown up.

Subsequently, in step S43, a feature quantity of the image is calculated in the camera control unit 10 from an image signal of the image acquired in the step S42. Then, in step S43, a similar image similar to the image acquired in the step S42 is retrieved from among the reference images stored in the internal memory 20 or the storage device 22 on the basis of the feature quantity.

Moreover, in step S45, the similar image retrieved in the step S44 is displayed in the liquid crystal finder 24a along with an input image 66a as a similar screen 66b, for example, as shown in FIG. 12B. In other words, two of the input image 66a and the similar image 66b are simultaneously displayed as the image 66 displayed in the liquid crystal finder 24a.

Thereafter, the user adjusts the composition of the camera 30 while looking at the similar image 66b in the liquid crystal finder 24a. Then, when it is determined by the user that the input image 66a and the similar image 66b are similar to each other, the routine proceeds to step S46, and actual photographing is carried out.

In this way, according to the sixth embodiment, the user changes the composition while looking at the both of the input image and the similar image, and thus, it is possible to visually confirm how much the composition must be moved actually.

Further, changing of a moving direction of the composition has been described in the example described above. However, it is not limited thereto, and it goes without saying that change can be made by carrying out the same operations also in the case of a zoom operation.

### Seventh Embodiment

In the first to sixth embodiments described above, the descriptions have been made supposing that the reference images are stored in the internal memory 20 or the storage device 22 in the camera 30. In contrast thereto, in a seventh embodiment, a server remote from the camera 30 serving as an image pickup device is provided via a communication line such as the Internet or a telephone network, and at least some of the reference feature information are stored in the server to be acquired to the camera side by utilizing the communication line.

FIG. 13 is a diagram schematically showing a configuration of a camera system to which a photographing system according to the seventh embodiment of the present invention is applied.

As shown in FIG. 13, the camera 30 is designed to make a communication with a server 70 provided outside of the camera 30 via a communication line. The reference images and the related information stored in the internal memory 20 or the storage device 22, which have been descried in the first to sixth embodiments described above, are kept at the server 70 side. For this reason, image information at the camera 30 side are transmitted to the server 70 side by utilizing the communication line via an antenna 30a serving as communication means, and the transmitted information are retrieved at the server 70 side, so that a similar image is acquired.

Note that the configuration in the camera 30 is the same as that shown in the block diagram of FIG. 1 or FIG. 7. In addition, operations for setting a composition of the camera are the same as those in the first to sixth embodiments described above except that the reference images are acquired from the server via the communication line, and therefore, descriptions thereof here will be omitted.

In this way, according to the seventh embodiment, a server is provided at a remote place, retrieval processing is carried out at the server side by means of communication means, and high-load processing is made at the server side, so that processing can be carried out without putting load on the processing at the camera side. Further, as the reference feature information, a larger number of reference images can be stored as compared with the case in which the reference images are stored in the storage device in the camera, which makes it possible to correspond to a greater diversity of scenes.

The embodiments of the present invention have been described above. The present invention can be modified and implemented within a range which does not deviate from the gist of the present invention in addition to the embodiments described above.

Consideration can be given to, for example, a case where only feature quantities of images are stored as reference feature information in a database. If a necessary feature quantity can be determined by applying an operation for calculating a feature quantity relating to an acquired image, it is possible to calculate a degree of similarity. Provided that only the feature quantities thereof are stored in the database even if direct images are not registered in the database, it is possible to handle it by using the technique described above in the same way as in a case where an image itself is not necessarily registered in the database in particular.

Moreover, inventions at various stages are included in the embodiments described above, and various inventions can be extracted by appropriately combining a plurality of disclosed components. For example, even if some of the components are omitted from all the components shown in the embodiments, the problems discussed in the “Problems to Be Solved” section can be solved. When the effects described in the “Advantages of the Invention” section can be achieved, the configuration from which the components have been omitted can be extracted to be the present invention.

In accordance with the present invention, it is possible to provide a photographing system and a photographing method by which it is possible even for a beginner to easily obtain an image satisfactorily composed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A photographing system comprising:
a calculation unit which calculates a feature quantity of an acquired image acquired from an image pickup element;
a database which stores plural types of reference feature information having a feature quantity serving as a reference at a time of determining a composition;
a retrieval unit which retrieves reference feature information from the database having a feature quantity similar to the calculated feature quantity of the acquired image by comparing the feature quantity calculated in the calculation unit and the reference feature information stored in the database; and
a report unit which reports information relating to composition on the basis of a result of comparison between the calculated feature quantity and the reference feature information retrieved by the retrieval unit.

2. The photographing system according to claim 1, wherein:
the reference feature information stored in the database are classified for each of photographing modes, and
the retrieval unit carries out retrieval of reference feature information classified so as to correspond to a photographing mode set by a user.

3. The photographing system according to claim 1, wherein the report unit reports information relating to a change of direction of composition as the information relating to composition.

4. The photographing system according to claim 1, wherein the report unit reports information relating to zooming as the information relating to composition.

5. The photographing system according to claim 1, further comprising an operating unit for a user to set at least some of the reference feature information.

6. The photographing system according to claim 1, wherein:
the calculation unit calculates information relating to faces of persons as the feature quantity of the acquired image, and
the retrieval unit carries out retrieval by using the information relating to faces of persons at a time of retrieving reference feature information from the database.

7. The photographing system according to claim 1, further comprising a direction finding unit which finds whether a longitudinal direction of the composition is a horizontal direction or a vertical direction, wherein the retrieval unit carries out retrieval with respect to reference feature information corresponding to vertical composition or transverse composition.

8. The photographing system according to claim 1, wherein:
the system includes an image pickup device having the image pickup element, and a server which communicates with the image pickup device via a communication unit, and
at least part of the database is provided at the server.

9. A photographing system comprising:
a calculation unit which calculates a feature quantity of an acquired image acquired from an image pickup element;
a database which stores plural types of reference feature information having a feature quantity serving as a reference at a time of determining a composition;
a retrieval unit which retrieves reference feature information from the database having a feature quantity similar to the calculated feature quantity of the acquired image by comparing the feature quantity calculated in the calculation unit and the reference feature information stored in the database; and
a direction control unit which controls a direction of a photographing device on the basis of a result of comparison between the calculated feature quantity and the reference feature information retrieved by the retrieval unit.

10. The photographing system according to claim 9, wherein:
the reference feature information stored in the database are classified for each of photographing modes, and
the retrieval unit carries out retrieval of reference feature information classified so as to correspond to a photographing mode set by a user.

11. The photographing system according to claim 9, further comprising an operating unit which selects and sets at least some of the reference feature information.

12. The photographing system according to claim 9, wherein:
the calculation unit calculates information relating to faces of persons as the feature quantity of the acquired image, and
the retrieval unit carries out retrieval by using the information relating to faces of persons at a time of retrieving reference feature information from the database.

13. The photographing system according to claim 9, further comprising a direction finding unit which finds whether a longitudinal direction of the composition is a horizontal direction or a vertical direction, wherein the retrieval unit makes retrieval with respect to reference feature information corresponding to vertical composition or transverse composition.

14. The photographing system according to claim 9, wherein:
the system includes an image pickup device having the image pickup element, and a server which communicates with the image pickup device via a communication unit, and
at least part of the database is provided at the server.

15. A photographing method for assisting in composing a scene, comprising:
a first step of calculating a feature quantity of an acquired image acquired from an image pickup element;
a second step of retrieving reference feature information from a database having a feature quantity similar to the calculated feature quantity of the acquired image by comparing the calculated feature quantity and reference feature information having a feature quantity serving as a reference at a time of determining a composition, which are stored in the database; and
a third step of reporting information relating to composition on the basis of a result of comparison between the calculated feature quantity and the retrieved reference feature information.

16. The photographing method, according to claim 15, wherein the third step reports information relating to a change of direction of composition as the information relating to composition.

17. The photographing method, according to claim 15, wherein the third step reports information relating to zooming as the information relating to composition.

18. The photographing method according to claim 15, further comprising a fourth step of setting at least some of the reference feature information by a user before the second step.

19. The photographing method according to claim 15, wherein:
the first step calculates information relating to faces of persons as the feature quantity of the acquired image, and
the second step carries out retrieval by using information relating to faces of persons at a time of retrieving reference feature information from the database.

20. A photographing method for assisting in composing scene, comprising:
a first step of calculating a feature quantity of an acquired image acquired from an image pickup element;
a second step of retrieving reference feature information from a database having a feature quantity similar to the calculated feature quantity of the acquired image by comparing the calculated feature quantity and reference feature information having a feature quantity serving as a reference at a time of determining a composition, which are stored in the database; and
a third step of controlling a direction of a photographing device on the basis of a result of comparison between the calculated feature quantity and the retrieved reference feature information.

21. The photographing method according to claim 20, further comprising a fourth step of setting at least some of the reference feature information by a user before the second step.

22. The photographing method according to claim 20, wherein:
the first step calculates information relating to faces of persons as the feature quantity of the acquired image, and
the second step carries out retrieval by using information relating to faces of persons at a time of retrieving reference feature information from the database.
